(19) United States
(12) Patent Application Publication
(10) Pub. No.: US 2011/0138286 A1
(43) Pub. Date: Jun. 9, 2011

(54) Voice assisted visual search

(76) Inventors: Viktor Kaptelinin, Hornefors (SE); Elena Oleinik, Hornefors (SE)

(21) Appl. No.: 12/852,469

(22) Filed: Aug. 7, 2010

Related U.S. Application Data
(60) Provisional application No. 61/273,673, filed on Aug. 7, 2009.
(60) Provisional application No. 61/277,179, filed on Sep. 22, 2009.

(51) Int. Cl. G06F 3/16; G06F 3/048

(52) U.S. Cl. 715/728

(57) ABSTRACT

The invention discloses a method and apparatus for (a) processing a voice input from the user of computer technology, (b) recognizing potential objects of interest, and (c) using electronic displays to present visual artefacts directing user's attention to the spatial locations of the objects of interest. The voice input is matched with attributes of the information objects, which are visually presented to the viewer. If one or several objects match the voice input sufficiently, the system visually marks or highlights the object or objects to help the viewers direct his or her attention to the matching object or objects. The sets of visual objects and their attributes, used in the matching, may be different for different user tasks and types of visually displayed information. If the user views only a portion of a document and user's voice input matches an information object, which is contained in the entire document but not displayed in the current portion, the system displays a visual artefact, which indicates the direction and distance to the object.

### CROSS-REFERENCE TO RELATED APPLICATIONS

Provisional Patent Application of Viktor Kaptelinin and Elena Oleinik, Ser. No. 61/273,673 filed Aug. 7, 2009

Provisional Patent Application of Viktor Kaptelinin, Ser. No. 61/277,179 filed Sep. 22, 2009

### FEDERALLY SPONSORED RESEARCH

Not Applicable

### SEQUENCE LISTING OR PROGRAM

Not Applicable

### 1. BACKGROUND OF THE INVENTION

The invention relates to presentation of information to users of computer technologies using electronic displays. The aim of the invention is to assist a person viewing information using an electronic display (thereafter, “viewer”) in visual search, that is, in visually locating an object or objects of interest among a plurality of other objects simultaneously presented to the viewer, whereby the viewer is capable of more efficiently focusing his or her visual attention on relevant visual objects of interest.

Current digital technologies display vast amounts of information on electronic displays and the user may have problems with finding objects of relevance. Examples of electronic displays are monitors of personal computers, mobile computer devices such as smartphones, displays at traffic control centers, Arrivals/Departures displays at airports, TV-screens or projector-generated images on projector screen controlled by game consoles, and so forth. Electronic displays often present numerous information objects (or units of information), such as individual words, descriptions (such as flight description on a Departures monitor), icons, menu items, map elements, and so forth. In addition, head-up displays (HUD) and other augmented reality displays overlay computer generated images on the images of physical images, viewed by a person. When a large amount of visual information is presented to a person, a person may experience problems with visual search, that is, focusing attention on relevant information. In particular, finding the needed object, such as the gate number of a certain flight on a Departures monitor at the airport, may take additional time and effort and have negative consequences, in terms of both performance and user experience. The problems are especially acute when a person is viewing a complex visual image, such as a large map or picture, by using a window of a limited size, such as a small desktop window of a personal computer or a small-screen device, such as a smartphone or other mobile device.

The invention disclosed in this document addresses the above problem by employing user's voice input. To the best of applicants' knowledge, this subject matter is novel. Prior art teaches using voice commands as alternatives to commands issued through manually operating a pointing device and keyboard. Prior art also teaches voice commands used in combination with manual location of objects of interest. However, it does not teach using voice input to help the user visually locate an object of interest.

### 2. SUMMARY OF THE INVENTION

Visual search, that is, locating an object of relevance embedded in a complex visual array containing multiple information objects can require time and effort. For instance, finding a town on a map of an area, a certain flight on a Departures monitor at the airport, a file icon in a crowded folder window of a graphical user interface, and so forth, can be tedious. It is not uncommon for a person to ask other people for help: a person would say something like “Where is this <name> town (flight, icon)?” and another person would point with his or her finger to the area of a display, where the object in question is located. The disclosed invention employs a similar principle. However, in the context of the present invention a computer system, not another human being, is playing the role of a helper.

For instance, the user may view a map presented on a display and try to look up a specific town but find it difficult because of a huge amount of information on the map. The user may repeatedly say the name of the town, e.g.: “Mancos . . . Mancos . . . ” The system would recognize the name and highlight it on the map. Or the user may look at the web page and ask himself or herself “how do I PRINT it?” The system would highlight the “Print” button that can be used to print the page.

The present invention can be essentially summarized as follows. When trying to find an object embedded in a complex visual image, the person describes out loud the object he or she is trying to locate, e.g., utters a word or phrase describing a certain property or attribute of the object in question, such as its name. The system uses this voice or speech input (“voice” and “speech” are used in the context of this invention interchangeably) to identify the likely object or objects. These likely object or objects is (are) highlighted with visual clues, directing visual attention of the person to the spatial location, where the object or objects in question are located.

In other words, the invention discloses a method and a system, according to which a system recognizes speech utterances produced by the user when he or she is finding a certain object in a complex visual array and provides visual clues that direct user's information to object or objects that may correspond to the desired object. The invention discloses a method and apparatus for assisting a user of a computer system, comprised of at least one electronic display, a user voice input device, and a computer processor with a memory storage, in viewing a plurality of visual objects, the method comprising the method steps of (a) creating in computer memory a representation of a plurality of visual objects; and (b) displaying said plurality of visual objects to the user; and (c) detecting and processing a voice input from a user; and (d) establishing, whether an information in the voice input matches one or several representations of visual objects comprising said plurality of visual objects; and (e) displaying visual artifacts highlighting spatial locations of visual object or visual objects, which match the information in the voice input, whereby highlighting of said matching visual object or visual objects assists the user in carrying our visual search of visual objects of interest.

The invention applies not only to conventional electronic displays, such as personal computer monitors, which display objects of interest, but also to head up displays (HUD), where users view physical objects through transparent displays, and computer-generated images are overlaid on the view of physical objects. For instance, a HUD having the form factor of eyeglasses can help a mother locate her child in a group of children. The mother would pronounce the name of the child, and a visual artefact would be projected on the eyeglasses to mark the image of child on the visual scene viewed by the mother.

In other words, the subject matter of the invention extends to cases, when the plurality of displayed visual objects represents a plurality of physical objects observed by the user, and the highlighting visual artefacts are displayed by overlaying said visual artifacts on a visual image of said plurality of displayed visual objects using a head up display.

Locating an object of relevance embedded in a complex visual image is especially difficult when the image is viewed through a window, which only shows a portion of the image comprising the entire window-related information. For instance, finding a town on a map of an area using a smartphone, a file icon in a crowded folder window of a graphical user interface viewed through a small window, and so forth, can be tedious. The object may not be displayed in the portion actually displayed to the user. In that case the system would receive user's voice as an input, recognize the name of the town, and provide a pointer, that is, a visual clue in the shape of an arrow, which indicates to the user, to which direction the user should navigate the window to make the town visible.

The invention differs from prior art, and, in particular, voice commands. The present invention supports existing users' strategies of interacting with computer systems by more efficiently managing users' visual attention. It does not teach using voice for changing the state of the system; it only teaches adding visual highlights or object selection, intended for the user. Voice commands, on the other hand, teach an alternative method of operating a system. Instead of drawing user's attention to potentially relevant objects, voice commands teach changing the system state.

As opposed to voice commands, the present invention teaches highlighting/selecting an object (or objects) and making it possible for the viewer to focus his or her attention on the object without causing a state change of the system. Voice commands, on the contrary, cause changes in the state of the system rather than assist the user in directing his/her attention on relevant objects.

In addition, because of these features, the present invention, as opposed to voice commands, is safe to use. When issuing voice commands, the user needs to impose special control over his or her utterances to avoid negative effects. The present invention does not need that. Whatever the user says does not change the state of the system, only provides suggestions to the user but cannot result in a damage caused by voicing an incorrect command; the suggestions can be ignored by the user.

The invention is also different from prior art related to multimodal input. For instance, the “put that there” method (Bolt, 1980) teaches manually, for instance, using a pointer, locating an object of interest, selecting it using voice (“put THAT”), then manually selecting the destination location and marking it using voice (“put that THERE”). This method helps the user, who already knows the locations of interest, to convey a command to the system, but it cannot help the user locate an object if the user does not know the location.

### 3. DESCRIPTION OF FIGURES

FIG. 1 depicts an abstract architecture of the first embodiment of the invention.

FIG. 2 depicts a visual highlighting according to the first embodiment.

FIG. 3 depicts a simplified flow chart illustrating the method according to the first embodiment.

FIG. 4 depicts a visual pointer according to the fourth embodiment.

FIG. 5 illustrates the method of determining the orientation, location, and size of the visual pointer according to the fourth embodiment of the invention.

### 4. DETAILED DESCRIPTION OF THE INVENTION

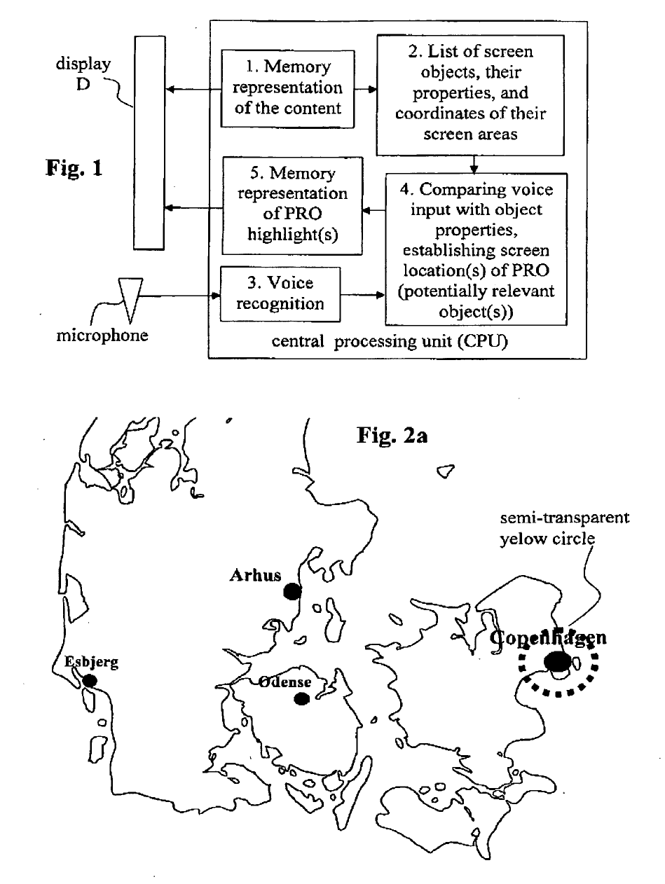

The first embodiment represents the case, when both the plurality of displayed visual objects and the highlighting visual artefacts are displayed on a same electronic display. According to the first preferred embodiment of the invention, the user views an electronic display, which displays an image comprised of a variety of objects, for instance a map of Denmark displayed on the monitor of user's laptop, with the aim of locating certain objects of interest, for instance, certain cities and towns. FIG. 1 shows a simplified representation of the system, which includes: (a) an electronic display D, (b) a microphone M, and a (3) central processing unit CPU.

CPU is comprised of several functional sub-units 1-5. Sub-unit 1 is a memory representation of the content displayed on display D. Sub-unit 2, which can be a part of sub-unit 1, is a memory representation of a list of objects displayed on display ID, and their properties. The properties may include the name, description or a part of description, including various kinds of metadata that is already provided by computer systems, electronic documents, web sites, etc. The properties can also include visual properties, such as color, size, etc. For instance, cities and towns on a map of Denmark are represented as printed words and circles of certain color and size. The representations also occupy certain areas of display D, that is, have certain screen coordinates.

A list of objects and their properties can also be generated by a separate system module, implemented in a way obvious to those skilled in the art, which module would scan the memory representation of the image, presented (or to be presented) on the electronic display, identify units of information/types of information objects (such as words, geometrical figures, email addresses, or hyperlinks), describe their properties (e,g, meanings of words, colors of shapes, URLs of links), and establish their screen coordinates.

Establishing a match between said voice input and visual objects can be employed by finding out whether the word or words uttered by the user, as well as their synonyms and translations to other languages, are contained in meta-data about displayed visual objects. Meta-data about a displayed visual object can include a description of attributes (metadata) of visual objects, which can be displayed by operating upon the displayed visual object. For instance, a meta-data about a pull-down menu button can include the list of commands available by opening the menu.

Sub-unit 3 receives and recognizes inputs from microphone M. For instance, the voice input is recognized as “Copenhagen”. Sub-unit 4 receives inputs from both sub-unit 3 and sub-unit 2. It compares an input from the microphone with the list of objects and their properties. For instance, it can be found that there is a match between the voice input (“Copenhagen”) and one of the screen objects (a larger circle and a word “Copenhagen”) located in a certain area of the screen.

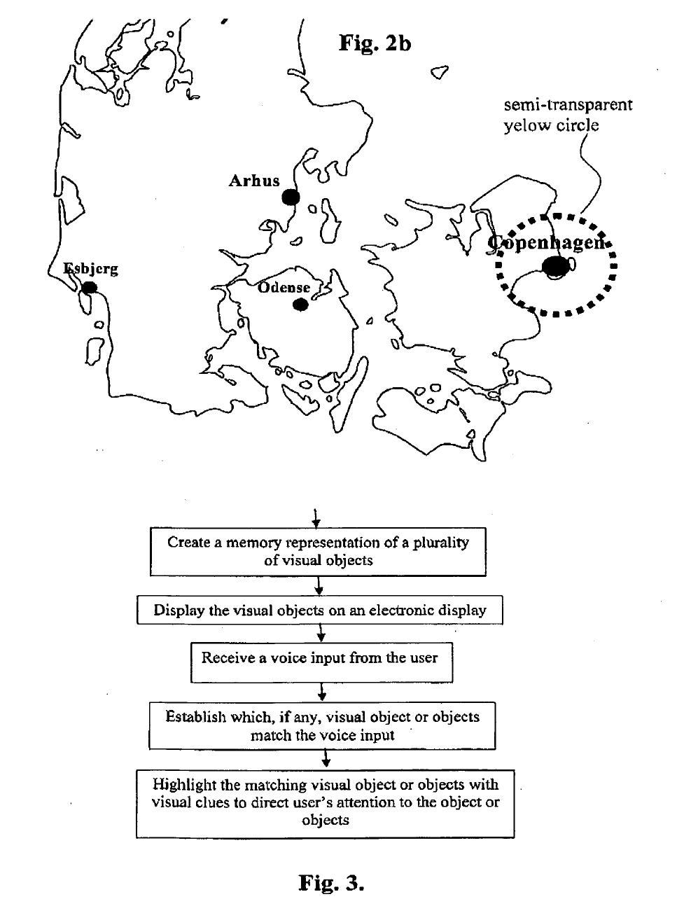

Sub-unit 5 receives the screen coordinates of the identified screen object (or objects) and displays a visual highlight, attracting user's attention to the object. For instance, a pulsating semi-transparent yellow circle with changing diameter is displayed around the location of Copenhagen on display D (See FIG. 2) for 3 seconds.

FIG. 3 depicts a simplified flow chart illustrating the method of the invention. Obvious modifications of the method, including changes in the sequence of steps, are covered by the present invention. For instance, it is obvious that memory representation can be created after receiving a voice input.

The screen object can be also selected for further user actions. For instance, if the user says “Weather” when viewing a news website, and the “Weather” link is highlighted, the link can be also selected, for instance by moving the pointer over the link, and pressing a mouse button will cause the system follow the link. In other words, a highlighted visual object can be also selected as a potential object of a graphical user interface command. If the system's recognition is not accurate, and the user actually needs another object, the user may simply ignore the system's selection.

If there is a close enough match between voice input and several alternatives (e.g., “Hjorring” and “Herning”), then both screen objects are highlighted. Alternatively, if there is a match between voice input and several alternatives, only the most likely option is highlighted. If this is not what the user needs, the user says “no” or gives other negative response, and the next likely alternative is highlighted.

The closer the match between the voice input and the screen object(s), the brighter color is used for highlighting. The louder is the voice input, the more frequent the pulsation of the highlighting visual clue is. Of course, these are just examples, and it is obvious that other visual attributes can be used.

If the properties of screen objects are described in one language (e.g., English), and the user voice input is made in another language (e.g., Swedish), establishing a match between the voice input and screen objects can involve translation/multi-language voice recognition. For instance, if the user says “Shjoepenharnn” (it is how the word “Köpenhamn”, the Swedish name of “Copenhagen”, approximately sounds), the system will recognize it as a Swedish word, translate to English, and establish a match with the screen object “Copenhagen”. Alternatively, the memory representation of screen objects and their properties can include multi-language description. In that case, after recognizing a voice input as the Swedish word “Kopenhamn”, the system will find the word in the description of the screen object “Copenhagen” and establish a match. In other words, language translation means are provided for matching a same representation of a plurality of visual objects to user's voice input expressed in a plurality of languages.

Feedback. When a translation is needed, or for any other reason the match is not precise, the system may present a visual or audio feedback message clarifying the highlighting, for instance, “Copenhagen” is the English equivalent of Swedish “Köpenhamn”, or “Arkiv” is the Swedish equivalent of “File”. The message can be in either English or Swedish, preferably in the language of the voice input

Machine learning. The system can learn from user's actions, including their negative responses and the languages they prefer, to adjust itself to individual users. For instance, if the user repeatedly uses a certain language, the language would be set as the default language in voice recognition and feedback messages. If several users use the system, the system can identify each user by his or her voice, and adjust itself to each user. Therefore, adjusting to individual users can employ machine learning algorithms.

Setting options and preferences. The user or other people involved can set the preferences of the system, including: (a) selecting the categories and range of objects used in matching and subsequent highlighting (in case of maps: cities, special objects like bridges, hotels, tourist attractions, counties and provinces, etc., (b) selecting recognized languages, (c) selecting types of specific attributes of highlighting visual clues, (d) switching the voice assisted attention management system on or off, (e) choosing whether or not the highlighted objects are also selected, so that users can carry out various actions with the objects, and (f) choosing more strict or more relaxed criteria for considering an object as matching the voice input (exact word in the name, similar sounding word in the name, exact word in the description, etc.). Other preferences, options, and parameters are possible to implement, as well.

According to the second embodiment, several users use the system when simultaneously viewing a public display. The system identifies the users by their respective voices and displays highlighting using different visual clues (for instance, colors) for different users. The users may use publicly available microphones for voice assisted viewing, and they can also employ personal devices, such as mobile phones, which are equipped with microphones and wirelessly connected to the system that controls the public display. In the latter case system feedback messages can be presented to users through displays or speakers of their mobile devices. In other words, users are differentiated by their voice attributes, and attributes of the highlighting visual artefacts are individually adjusted to individual users. For instance, several users, who are using the system generally simultaneously, are provided with different highlighting visual clues.

According to the third embodiment, the system assists the user in focusing their visual attention on objects, which are not directly displayed on a display but can be accessed through the display. For instance, the user may say “Save” when he or she is looking for the “Save” command, and the system would highlight the “File” menu, inviting the person to open the menu and thus find the “Save” command (the latter can also be highlighted). Or the user says “Florence” when viewing a web page, and the system would highlight the “Italy” link on the page, through which the user can access a map of Florence. Or when the user says “Vacations”, the system highlights the folder “Pictures”, by opening which folder the user can access a folder named “Vacations”. In other words, a memory representation of a displayed visual object includes a description of visual objects, which can be accessed through operating upon said displayed visual object.

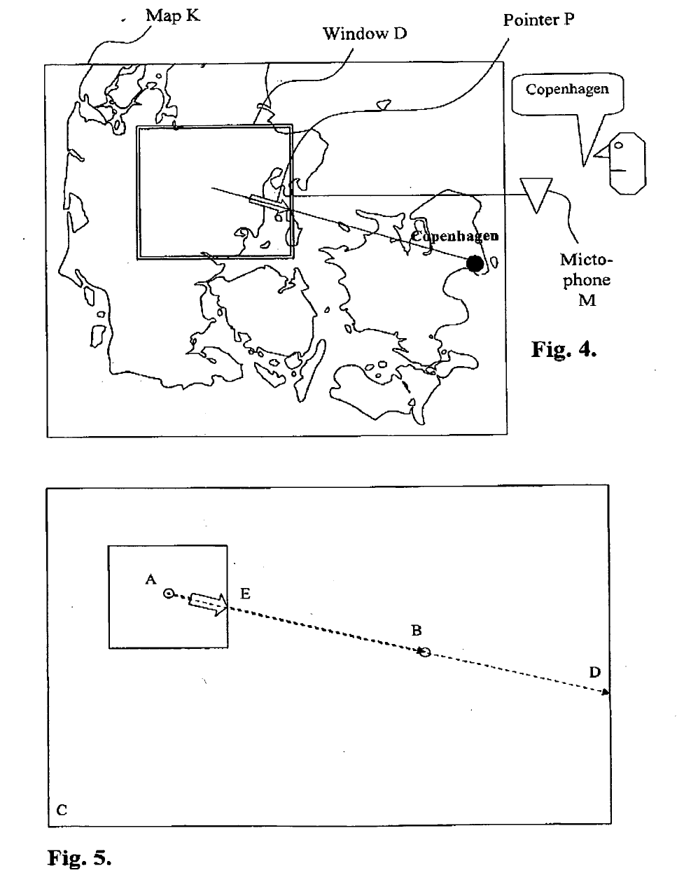

According to the fourth preferred embodiment of the invention, the user views an electronic display, which displays an image comprised of a variety of objects, for instance a map of Denmark displayed on the display of user's mobile device, with the aim of locating certain objects of interest, for instance, certain cities and towns. The map is too big for the display, and the user can only view the map through a window displaying only a portion of the map. FIG. 4 shows a simplified representation of the system, which includes: (a) Map K, (b) window D, which shows only a part of K, (c) visual artefact, pointer P, (d) a microphone M, and a (e) central processing unit CPU.

CPU is comprised of several functional sub-units 1-5. Sub-unit 1 is a memory representation of the whole content, which is, in the present case, map K. Sub-unit 2, which can be a part of sub-unit 1, is a memory representation of a list of objects displayed on map K, and their properties. The properties may include the name, description or a part of description, including various kinds of metadata that is already provided by computer systems, electronic documents, web sites, etc. The properties can also include visual properties, such as color, size, etc. For instance, cities and towns on a map of Denmark are represented as printed words and circles of certain color and size. The representations also occupy certain areas of map K, that is, have certain map coordinates (the point with coordinates X=0, Y=0, can be, for instance, the bottom left corner of the whole image).

Sub-unit 3 receives and recognizes an input from microphone M. For instance, the voice input is recognized as “Copenhagen”. Sub-unit 4 receives inputs from both sub-unit 3 and sub-unit 2. It compares the input from the microphone with the list of objects and their properties. For instance, it is found that there is a match between the voice input (“Copenhagen”) and one of the objects located in a area of the whole image, —a circle and an associated word “Copenhagen” denoting the location of the city with this name on the map K—which is not displayed in the window.

Sub-unit 5 receives the screen coordinates of the identified object (or objects) and displays a visual pointer, indicating the direction, in which the user needs to move/scroll the window in order to see the object. For instance, an arrow pointing to the direction of Copenhagen's location on a virtual map of Denmark, with the length generally corresponding the distance to the location, can be displayed in the window.

The orientation, location, and size of a visual pointer are determined as follows:

Orientation and location: The pointer is an arrow, placed along the line connecting two points on the virtual map K, the center of the window (point A, see FIG. 4) and the “Copenhagen” object on the map K. The arrow is pointing in the direction of the “Copenhagen” object. The tip of the arrow is located generally near the edge of the window, closest to the “Copenhagen” object.

Size. The length of the window is proportional to the distance to the object of interest. For instance, the length of the arrow pointing to Copenhagen can be calculated as L=AE*(AB/AD), where
AE—the distance between the center of the window and the intersection of the edge of the window and the line connecting the center of the window with the “Copenhagen” object (see FIG. 5).
AB—the distance between the center of the window and the “Copenhagen” object (see FIG. 5).
AD—the distance between the center of the window and the intersection of the edge of the map K and the extension of the line connecting the center of the window with the “Copenhagen” object (see FIG. 5).

Therefore, the fourth preferred embodiment discloses a method and apparatus wherein only a portion of the plurality of visual objects is displayed to the user and if the voice input matches an object that is not displayed in the portion, then displaying a visual artefact pointing in the direction, in which the display should needs to be moved in order to make the matching object to be displayed to the user. The length of the pointing visual artefact is proportional to the distance for which the display needs to be moved in order to make the matching object to be displayed to the user. A variation of the embodiment is making it possible for the user to operate a pointing visual artifact to cause the display move to display the matching object. For imstance, if a small computer window only displays a part of a map of Sweden and only shows Northern Sweden, and the user says “Stockholm”, the system will display an arrow pointing south. Clicking the arrow could move the window down to display Stockholm.

What we claim as our invention is as follows:

1. A method for assisting a user of a computer system, comprised of at least one electronic display, a user voice input device, and a computer processor with a memory storage, in viewing a plurality of visual objects, the method comprising the method steps of
creating in computer memory a representation of a plurality of visual objects; and
displaying said plurality of visual objects to the user; and
detecting and processing a voice input from a user; and
establishing, whether an information in the voice input matches one or several representations of visual objects comprising said plurality of visual objects; and
displaying visual artifacts highlighting spatial locations of visual object or visual objects, which match the information in the voice input,
whereby highlighting of said matching visual object or visual objects assists the user in carrying our visual search of visual objects of interest.

2. A method of claim 1, wherein both the plurality of displayed visual objects and the highlighting visual artefacts are displayed on a same electronic display.

3. A method of claim 1, wherein the plurality of displayed visual objects represents a plurality of physical objects observed by the user, and the highlighting visual artefacts are displayed by overlaying said visual artifacts on a visual image of said plurality of displayed visual objects using a head up display.

4. A method of claim 2, wherein the user can set preferences, including at least: (a) selecting categories of objects used in matching and subsequent highlighting, (b) selecting a set of languages used in matching, (c) selecting types of specific attributes of highlighting visual artifacts, (d) switching voice assisted highlighting on or off, (e) choosing whether or not the highlighted objects are also selected, for subsequent graphical user interface commends, and (f) choosing strict or relaxed criteria for considering an object as matching the voice input.

5. A method of claim 2, wherein language translation means are provided for matching a same representation of a plurality of visual objects to user's voice input expressed in a plurality of languages.

6. A method of claim 2, wherein a highlighted visual object is also selected as a potential object of a graphical user interface command.

7. A method of claim 1, wherein a memory representation of a displayed visual object includes a description of visual objects, which can be accessed through operating upon said displayed visual object.

8. A method of claim 1, wherein users are differentiated by their voice attributes, and attributes of the highlighting visual artefacts are individually adjusted to individual users.

9. A method of claim 8, wherein adjusting to individual users employs machine learning algorithms.

10. A method of claim 8, wherein several users, who are using the system generally simultaneously, are provided with different highlighting visual clues.

11. A method of claim 1, wherein only a portion of the plurality of visual objects is displayed to the user and if the voice input matches an object that is not displayed in the portion, then displaying a visual artefact pointing in the direction, in which the display should needs to be moved in order to make the matching object to be displayed to the user.

12. A method of claim 11, wherein the length of the pointing visual artefact is proportional to the distance for which the display needs to be moved in order to make the matching object to be displayed to the user.

13. A method of claim 11, wherein a pointing visual artifact can also be operated by the user to cause the display move to display the matching object.

14. Apparatus, comprising at least an electronic display; and
a user voice input device; and
a computer processor, and a memory storage, which can be integrated with said computer processor; and
means for creating in computer memory a representation of a plurality of visual objects; and
means for displaying said plurality of visual objects to the user; and
means for detecting and processing a voice input from a user; and
means for establishing, whether an information in the voice input matches one or several representations of visual objects comprising said plurality of visual objects; and
means for displaying visual artifacts highlighting spatial locations of visual object or visual objects, which match the information in the voice input:
whereby highlighting of said matching visual object or visual objects assists the user in carrying our visual search of visual objects of interest.

15. An apparatus of claim 14, further comprising
means for displaying a portion of said plurality of visual objects to the user; and
means for establishing, whether the voice input matches at least one visual object selected from said plurality of visual objects, said at least selected object not displayed to the user; and
means for displaying a visual artefact pointing in the direction, in which a display needs to be moved to cause said at least selected object to be displayed to the user.

16. An apparatus of claim 14, wherein both the plurality of displayed visual objects and the highlighting visual artefacts are displayed on a same electronic display.

17. An apparatus of claim 14, wherein the plurality of displayed visual objects represents a plurality of physical objects observed by the user, and the highlighting visual artefacts are displayed by overlaying said visual artifacts on a visual image of said plurality of displayed visual objects using a head up display.
